(19) United States
(12) Patent Application Publication
(10) Pub. No.: US 2008/0044049 A1
(43) Pub. Date: Feb. 21, 2008

(54) Hearing aid with a battery compartment

(75) Inventors: Wai Kit David Ho, Singapore (SG); Wee Haw Koo, Singapore (SG); Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISSCHE TECHNIK GmbH

(21) Appl. No.: 11/823,730

(22) Filed: Jun. 28, 2007

(30) Foreign Application Priority Data
Jun. 28, 2006 (DE) 10 2006 029 815.2

(51) Int. Cl. H04R 25/00

(52) U.S. Cl. 381/323

(57) ABSTRACT

The invention relates to an electrical device with a battery compartment that all batteries can be accommodated therein and in the event that the battery dies, battery fluid is prevented from escaping into the interior of the electrical device. The battery compartment comprises a battery compartment casing which can be provided in or on an area of the electrical device, said battery compartment casing comprising a battery recess for accommodating a battery, with the battery being held in a predetermined position in the electrical device by a permanently magnetic area of the electrical device when the battery compartment casing is in a use position in or on the electrical device. The electrical device is in particular a hearing aid.

### CROSS REFERENCE TO RELATED APPLICATIONS

This application claims priority of German application No. 10 2006 029 815.2 filed Jun. 28, 2006, which is incorporated by reference herein in its entirety.

### FIELD OF THE INVENTION

The invention relates to a hearing aid, such as for instance a behind-the-ear hearing device, with a battery compartment.

### BACKGROUND OF THE INVENTION

A plurality of different, compact, battery-operated hearing devices exist, in which provision must be made for an exchangeable battery and/or rechargeable battery. For this purpose, many of these hearing devices comprise a battery compartment casing which can be manually activated by way of a hinge, said battery compartment casing being able to be snapped open and closed in order to change the battery, so that the user is able to change the battery without partially disassembling the hearing aid.

Batteries or rechargeable batteries are used as the power supply in all hearing aids and, depending on the type of use and the extent of the hearing loss, only provide sufficient electrical energy for a few days up to several weeks. It is thus necessary to guarantee a continually reliable battery change in a hearing aid and to keep any damage to the hearing aid as far as possible to a minimum in the event that the hearing aid battery dies.

As a result of the short service life, and thus the good sales prospects of these batteries in a growing market, a plurality of different hearing aid battery manufacturers exist, with the intention preferably being for a hearing aid to be operable using a relevant battery type from any manufacturer.

The problem here is that the sizes of the respective available battery types vary among different battery manufacturers and, if the whole hearing aid moves, a battery inserted into the battery compartment can thus move relative to the hearing aid and can thus cause dropouts and an interruption in the power supply during operation of the hearing aid or can result in damages during transportation.

A battery holder device is provided in a battery compartment casing of the battery compartment so that a battery inserted in the battery compartment of the hearing aid can no longer change its position relative to the hearing aid, e.g. as a result of movements of a wearer of the hearing aid.

In the prior art, (see also the explanations in the description of the Figures in FIG. 1), a battery holder device designed as a lug is located for this purpose in a recess of a wall of the battery compartment casing, said battery holder device being designed to be spring-like in a certain area and thereby enabling batteries of different sizes to be clamped in the battery compartment casing.

The problem here is that on the one hand the spring displacement of the lug cannot be selected large enough, as a result of the material and the dimensions of the battery compartment casing, that all batteries which are suitable for the relevant hearing aid can be clamped securely and permanently, some batteries are so small that the battery can no longer be clamped by means of the battery holder device. On the other hand, from an aesthetic viewpoint (clamping the battery and this itself should not be visible from the outside) and manufacturing-specific conditions, the recess is arranged in the wall of the battery compartment casing such that if the battery dies, in unfavorable circumstances, battery fluid can escape into the interior of the hearing aid, thereby resulting in damages and even in a total failure of the hearing aid. A battery holder device as an additional component increases the assembly costs and thus the price of the hearing aid.

In one embodiment, DE 694 34 389 T2 discloses a CIC hearing device having a permanent magnet on a battery holder device, which, in co-operation with a springy lug, holds a battery of the CIC hearing device in an open position. When the battery holder device is in the closed position, the battery is held in position by the battery holder device, a closing plate and an electrical spring contact. In a further embodiment, DE 694 34 389 T2 also discloses a CIC hearing device without a permanent magnet on a battery holder device. A compensation of different battery sizes takes place in both embodiments by way of an electrical spring contact.

With these embodiments, it is not possible to use a broad range of differently formed batteries in a CIC hearing device, since a spring displacement of the electrical spring contact is not sufficient to compensate for different battery sizes.

### SUMMARY OF THE INVENTION

It is thus the object of the invention to equip a hearing aid with a battery compartment such that on the one hand all batteries considered for the hearing aid can be accommodated therein and that on the other hand, if the battery dies, battery fluid is prevented from escaping into the interior of the hearing aid.

The object of the invention is achieved by a battery compartment for a hearing aid, such as for instance a behind-the-ear hearing device, with the battery compartment comprising a battery recess into which a battery or a rechargeable battery can be inserted, and at least one section of the hearing aid is designed to be permanently magnetic such that the permanently magnetic section holds the battery in the hearing aid in a predetermined position.

The object of the invention is also achieved by a battery compartment casing for a hearing aid, such as for instance a behind-the-ear hearing device, with the battery compartment casing comprising a battery recess, into which the battery can be inserted, with at least a section of the battery compartment casing being designed to be permanently magnetic such that it holds the battery in a predetermined position when said battery is in an inserted position in the battery recess.

The battery compartment of the hearing aid refers to an area in or on the hearing aid, e.g. a section, a space, a cavity, a vacuity, which, together with the battery compartment casing, forms the battery compartment.

It is herewith possible in accordance with the invention to replace the battery holder device designed as a lug and inadequate in the prior art with a permanent magnet, so that all batteries which are suitable for the hearing aid can be used, these are held simply by means of the permanent magnets. In accordance with the invention, it is also possible to do without the recess for the battery holder device so that, in the event that the inserted battery dies, liquid can no longer escape so rapidly into the interior of the hearing aid as in the prior art. By doing without the recess for the battery holder device, the corresponding area within the hearing aid may also no longer be structurally weakened. Such a predetermined breaking point is particularly problematic in the case of mechanically charged battery compartment casings.

With the first mentioned embodiment of the invention, it is possible to provide the permanently magnetic area and/or a permanent magnet in the hearing aid itself or on its battery compartment such that in the hearing aid, when the battery is inserted, this is held in a specific position by means of the permanent magnets. With the second embodiment of the invention, it is preferred to provide the permanently magnetic area and/or the permanent magnets in or on the battery compartment casing of the hearing aid. In comparison with the embodiment mentioned first, in this process the permanent magnet moves closer to the battery, which, in some circumstances, depending on the conditions in the hearing aid, can require a redesign of the battery compartment casing and/or its surroundings. The further inside the hearing aid the permanent magnet is arranged, in other words at a distance from the battery compartment casing, the stronger it must be to be able to hold the battery in its predetermined position in the hearing aid.

In preferred embodiments of the invention, the battery compartment casing can be swiveled or pulled out of the hearing aid, with the permanent magnet either being provided on or in the battery compartment casing, or in the vicinity of a battery compartment space in the hearing aid. In the first case, the battery assumes its fixed position in the battery compartment casing prior to its insertion/attachment into/onto the hearing aid. In the latter case, the battery only assumes its final position after insertion/attachment of the battery compartment casing into/onto the hearing aid. This likewise applies to a permanent magnet within the hearing aid itself.

In a preferred embodiment of the invention, the battery, in its inserted position in the battery compartment casing, is in direct contact with the permanently magnetic area of the battery compartment casing. The permanently magnetic area herewith preferably forms an integral section of the battery compartment casing. In such an embodiment, the battery holder device can function with the smallest possible magnetic flux density. Existing hearing aids can also be rebuilt/equipped with the battery compartment casing according to the invention.

In a further preferred embodiment of the invention, the permanently magnetic area is likewise preferably designed as an integral part of the battery compartment casing, but is not however in direct contact with the battery in its inserted position. The position of the permanently magnetic area in or on the battery compartment casing can herewith be somewhat freely selected and can herewith be better adjusted to the conditions of the hearing aid. Manufacturing-specific issues of the battery compartment casing can also be better considered. It is herewith likewise possible to subsequently provide an already existing hearing aid with this embodiment of the battery holder device according to the invention. An area between the permanently magnetic area and the battery is formed by a preferably paramagnetic or ferromagnetic area. A diamagnetic area between the permanent magnet and the battery is also possible if it is to require the conditions of the hearing aid. These above areas can be formed by a metal, a metal alloy, a plastic or also by ambient air.

In a preferred embodiment of the invention, the battery compartment casing comprises a preferably completely circular, hollow cylindrical wall which extends in the longitudinal direction. The permanently magnetic area is herewith a section or an area of this wall. It is herewith advantageous that battery compartment bodies for hearing aids for instance comprise such a hollow cylindrical wall, as a result of which it is possible according to the invention to redesign or reconstruct an already existing battery compartment casing of a hearing aid without having to change the hearing aid itself which is connected thereto. The permanently magnetic area must herewith be provided at least in/on the battery compartment casing. Nevertheless, the recess for the battery holder device provided in the prior art in the wall of the battery compartment casing is preferably also omitted, i.e. replaced with wall material.

In a preferred embodiment of the invention, both the permanently magnetic area of the battery compartment casing and the remaining battery compartment casing are made out of plastic, with the permanently magnetic area accordingly being manufactured from a magnetic plastic material. The battery compartment casing and the permanent magnet located therein or thereon are herewith manufactured in one single process step, preferably in a 2K injection molding method. Furthermore, it is possible to spray and/or cast the battery compartment casing onto the permanent magnets using an insert in an (injection-molded) casting tool.

In a preferred embodiment of the invention, a conventional material, which is preferably not permanently magnetic, is located on the exterior of the battery compartment casing and/or on the exterior of the hearing aid. The currently used material herewith touches the skin of the wearer, so that said user does not have to deal with allergic reactions or suchlike.

Further embodiments of the invention result from the remaining dependent claims.

### BRIEF DESCRIPTION OF THE DRAWINGS

The invention is described in more detail below on the basis of exemplary embodiments with reference to the appended drawings, in which:

FIG. 1 shows a battery compartment casing for a behind-the-ear-hearing device according to the prior art;

FIG. 2 shows an inventive battery compartment casing of an inventive behind-the-ear hearing device, and

FIG. 3 shows a behind-the-ear hearing device having the inventive battery compartment casing from FIG. 2.

### DETAILED DESCRIPTION OF THE INVENTION

The invention is described in more detail below with reference to a behind-the-ear hearing device and relates to an inventive battery compartment of the hearing device, consisting of an area of the hearing device and a battery compartment casing which can be accommodated on or in this area.

A battery compartment casing and an area on the behind-the-ear-hearing device reserved for this is referred to below as a battery compartment of the behind-the-ear hearing device. This area may be a cavity in a housing section for instance or also only partially a housing section of the BTE, with the battery compartment casing at least partially protruding from the latter. It is also possible for instance, to design the battery compartment casing itself as a housing part or housing section of the BTE, with a free space connecting to the housing of the BTE being referred to as the area. The battery compartment casing can as a rule completely or partially form a section of a housing of the BTE and lies continuously snugly against the housing of the BTE on the BTE with its relevant exterior side edges. Furthermore, a battery is quite generally understood below to mean an energy store, so that a rechargeable battery is to be included for instance in the term battery.

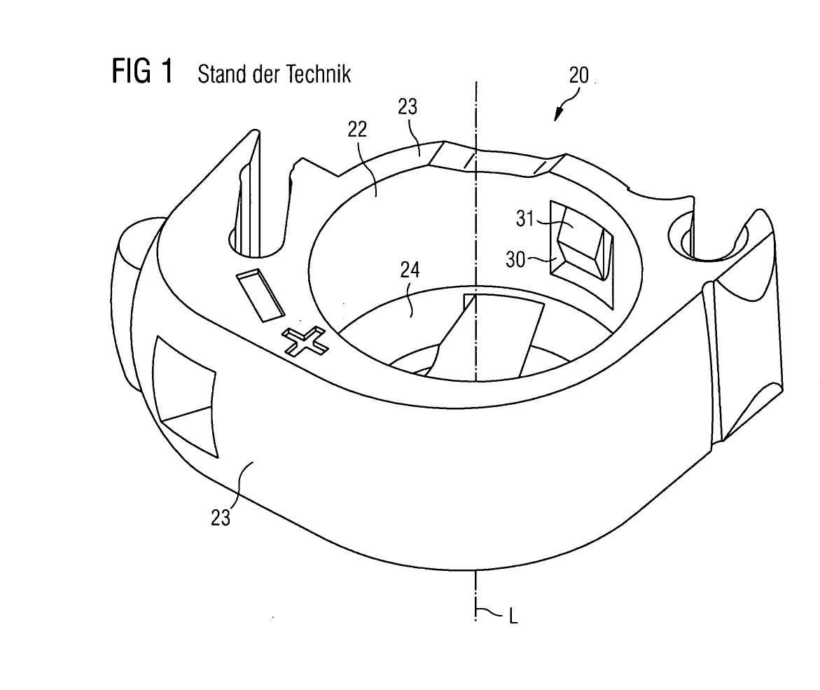

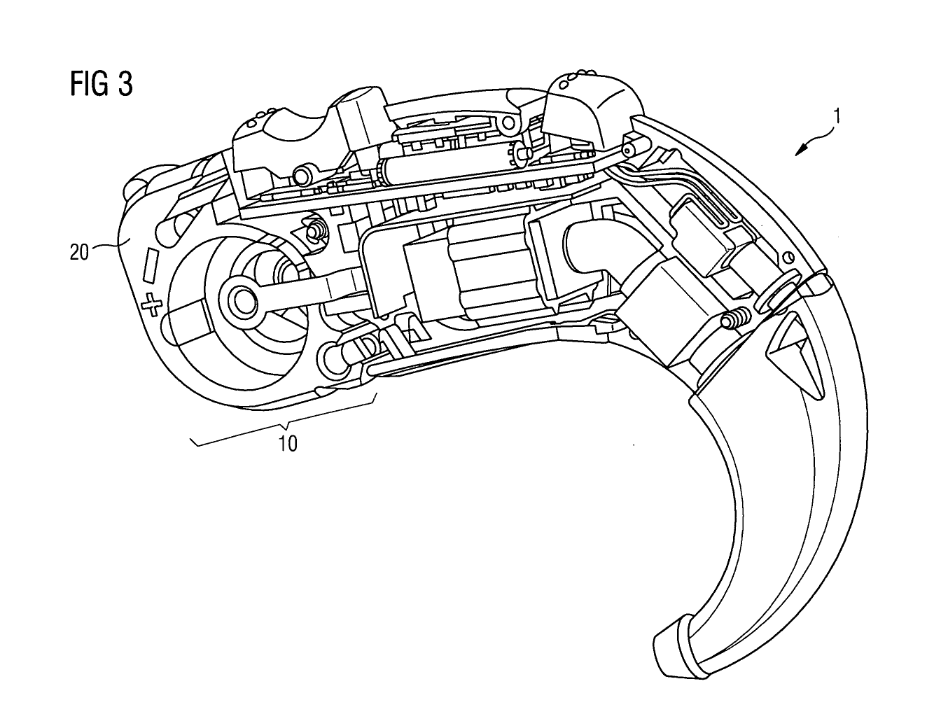

FIG. 1 shows a battery compartment casing 20 according to the prior art for a BTE 1 (See FIG. 3, which however shows a battery compartment casing 20 according to the invention). The battery compartment casing 20 essentially comprises a battery recess 22, which is delimited by a cylindrically circulating wall 23 extending in a longitudinal direction L. On the longitudinal edge (L-direction) of the wall 23, said wall 23 passes into a base 24, which renders it impossible for a battery inserted in the battery compartment casing 20 to fall out of this on the side of the battery compartment casing 20.

To ensure that a certain number of batteries from different manufacturers which are suitable for the BTE 1 can be accommodated in the battery compartment casing 20, the battery compartment casing 20 according to the prior art comprises a (passage) recess 30 in the wall 23, in which passage recess 30 a battery holder device 31 designed as a lug 31 is positioned. The lug 31 protrudes somewhat into the battery recess 22 and swivels back in the direction of the exterior of the battery compartment casing 20 when a battery is inserted. The battery can herewith be clamped inside the battery compartment casing 20 using the lug 31.

The problem with the battery compartment casing 20 according to the prior art is that if the installation height (in the longitudinal direction L) of the battery compartment casing 20 is minimal, the lug 31 can only be designed to be very short and can thus only comprise a very short spring displacement perpendicular to the longitudinal direction L. In this way, not all batteries of different manufacturers which are suitable for the BTE 1 can be securely clamped within the battery recess 22. Furthermore, for aesthetic and manufacturing-specific requirements, the position of the passage recess 30 within the BTE 1 (see FIG. 3) is problematic, since if the battery is dying, it is possible for battery fluid to escape through the recess 30 into the interior of the BTE 1, which can damage the BTE 1.

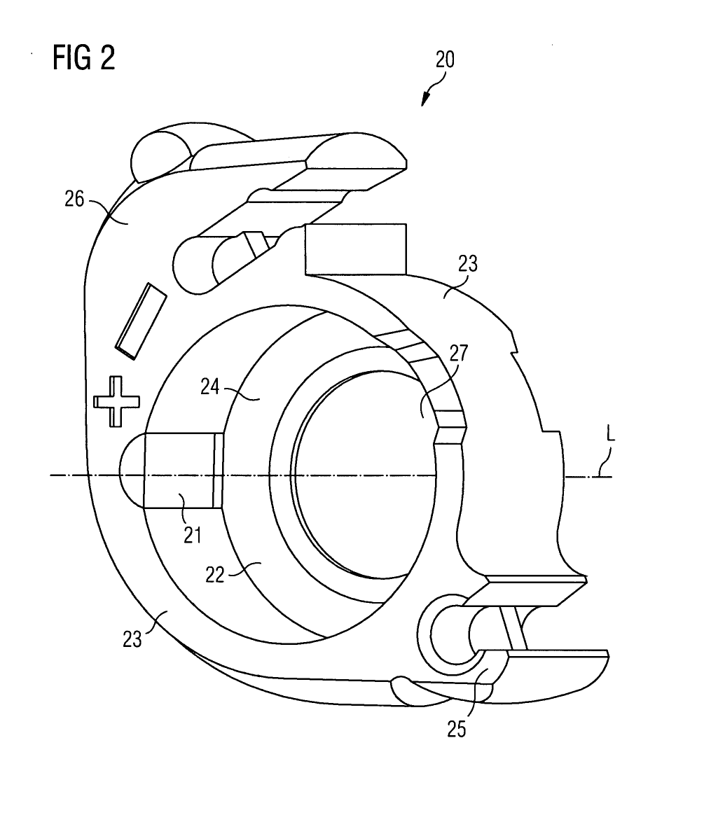

In accordance with the invention, a modified battery compartment casing 20 and/or a modified BTE 1 is now proposed. Also see FIG. 2 and 3 of the drawings.

The battery compartment casing 20 according to the invention is similar to the prior art, with it no longer comprising a recess 30 or a lug 31 designed as a battery holder device. In accordance with the invention, a section is permanently magnetically embodied on or in the battery compartment casing 20. This permanent magnet 21 of the battery compartment casing 20 can in principle be provided at any position in the battery compartment casing 20.

It is additionally possible to provide the permanently magnetic area 21 in or on the battery compartment casing 20, or as shown in FIG. 2, to design the original battery compartment casing 20 in a permanently magnetic manner in an area 21. It is also even possible, as previously indicated, not to provide the permanently magnetic area 21 in or on the battery compartment casing 20 itself, but instead outside thereof in the BTE 1. In such an embodiment of the invention, the permanently magnetic area 21 of the BTE 1 is then preferably located in the vicinity of a battery compartment casing 20 provided in or on the BTE 1 in its use position.

The permanently magnetic area 21 of the battery compartment casing 20 in FIG. 2 forms an axial, radial section or area of the wall 23 of the battery recess 22 which extends in a peripheral direction. In the exemplary embodiment shown, the permanently magnetic area 21 extends over the complete height (longitudinal direction L) of the wall 23. It is however also possible to design this area 21 to be shorter or to allow it to extend more into the peripheral direction or radial direction. The design of this area is generally almost arbitrary, provided it allows the heaviest battery for the BTE 1 to be permanently held in its position (normal use). The permanently magnetic area 21 also preferably does not extend to an exterior of the battery compartment casing 20, but instead ends within the wall 23, so that on the one hand a homogenous appearance image remains outwardly intact. The rear of the battery compartment casing 20 which cannot be seen in FIG. 2 forms an exterior surface of the BTE 1, and on the other hand the area 21 cannot come into contact with the skin of the wearer of the BTE 1 and thus can not provoke any new skin irritations, such as allergies for instance.

An at least partially circular passage recess 27 is located in the base 24 of the battery compartment casing 20, said passage recess being dimensioned on the one hand such that even the smallest battery cannot fall out but on the other hand is large enough so that if a battery compartment casing 20 protrudes or is removed from the BTE 1, the battery can be at least partially pushed out of the battery recess 22 using a finger, by pressing against the magnetic force of the permanent magnet 21. It is also possible to embody the base 24 in addition and/or at least partially as a permanently magnetic area 21.

The battery compartment casing 20 also comprises an extension 25 on its wall 23, said extension 25 being used for a jointed coupling of the battery compartment casing 20 to the BTE 1. Furthermore, the wall 23 has a locking element 26, which is used to lock the battery compartment casing 20 to the BTE 1.

The battery compartment casing 20 is preferably an injection-molded part, with, in the case of preferred inventive embodiments of the battery compartment casing 20, said battery compartment casing 20 either being manufactured in a 2K injection-molding method or in the case of an injection-molding method, the permanently magnetic area 21 being an insert. It is nevertheless naturally possible to manufacture the battery compartment casing 20 using another manufacturing method or from another material.

FIG. 3 shows the BTE 1 with an inventive battery compartment casing 20 in the use position of the battery compartment casing 20, i.e. the battery compartment casing is provided on and/or in an area 10 of the BTE 1. In the exemplary embodiment illustrated, the battery compartment casing 20 is connected to the BTE 1 in a pivotable manner by way of the joint extension 25.

The battery compartment casing 20 can be folded away from the BTE 1. In contrast to such battery compartment casings 20 which can be swiveled out, it is also possible to provide these on/in the BTE 1 in a manner in which they can be pulled out therefrom.

In an insertion position, the battery is located in the battery recess 22 of the battery compartment casing 20. The battery always only assumes its final position in the use position of the battery compartment casing 20. If the permanently magnetic area 21 is located in or on the battery compartment casing 20, the battery thus retains its relative position in the battery compartment casing 20 and no longer changes this in respect of the battery compartment casing 20 if this is provided in or on the BTE 1. If however the permanently magnetic area 21 is not located in or on the battery compartment casing 20, but instead in or on the BTE 1, the battery only assumes its relative position in the battery compartment casing 20 when the battery compartment casing 20 is provided in/on the BTE 1.

In the use position, the locking element 26 of the battery compartment casing 20 locks said battery compartment casing 20 to the BTE 1, with the BTE 1 preferably being able to be switched on/off by way of the battery compartment casing 20. To this end, the locking element 26 has two positions, with the BTE 1 being switched off using a partially pivoted position of the battery compartment casing 20 opposite to the BTE 1 and is switched on by moving the battery compartment casing 20 further into/onto the BTE 1.

1.-15. (canceled)

16. A hearing aid with a battery compartment, comprising:
a battery compartment casing comprising a battery recess that accommodates a battery,
wherein the battery compartment casing is configured to hold the battery in the hearing aid by a permanently magnetic area of the hearing aid.

17. The hearing aid as claimed in claim 16, wherein the permanently magnetic area of the hearing aid is provided in or on the battery compartment.

18. The hearing aid as claimed in claim 16, wherein the permanently magnetic area of the hearing aid is provided in or on the battery compartment casing.

19. The hearing aid as claimed in claim 16, wherein the battery directly contacts with the permanently magnetic area.

20. The hearing aid as claimed in claim 16, wherein the battery does not directly contact with the permanently magnetic area and a non-permanently magnetic area is provided between the permanently magnetic area and the battery.

21. The hearing aid as claimed in claim 20, wherein the non-permanently magnetic area is an area selected from the group consisting of: a paramagnetic area, a ferromagnetic area, and a diamagnetic area.

22. The hearing aid as claimed in claim 16, wherein the battery recess is delimited by a wall that at least partially circulates the battery compartment casing.

23. The hearing aid as claimed in claim 22, wherein the permanently magnetic area extends along a longitudinal direction of the wall.

24. The hearing aid as claimed in claim 22, wherein the wall is a hollow cylindrical section and is peripherally closed.

25. The hearing aid as claimed in claim 22, wherein the permanently magnetic area extends completely over the wall and passes into a base that prevents the battery from falling out in an insertion position.

26. The hearing aid as claimed in claim 25, wherein the base is at least partially a permanently magnetic area.

27. The hearing aid as claimed in claim 25, wherein the base comprises a passage recess that facilitates pressing the battery out from an insertion position in order to change the battery.

28. The hearing aid as claimed in claim 16, wherein the battery compartment casing comprises a plastic material.

29. The hearing aid as claimed in claim 16, wherein the permanently magnetic area comprises a material selected from the group consisting of: a metal, a metal alloy, and a ceramic oxide material.

30. The hearing aid as claimed in claim 16, wherein the battery compartment casing is manufactured by a 2K injection-molding method.

31. The hearing aid as claimed in claim 16, wherein the battery compartment casing is a casing selected from the group consisting of: a swivelable casing, a pullable casing, a pivotable casing, and a retractable casing.

32. The hearing aid as claimed in claim 16, wherein the battery compartment casing is in or on the hearing aid.

33. The hearing aid as claimed in claim 16, wherein the hearing aid is a behind the ear hearing aid.

34. An electrical device, comprising:
a battery compartment comprising a battery recess that accommodates a battery,
wherein the battery compartment is configured to hold the battery in the electrical device by a permanently magnetic area of the electrical device.

35. A method for holding a battery of an electrical device, comprising:
arranging a permanently magnetic area in the electrical device; and
holding the battery in the electrical device by the permanently magnetic area of the electrical device.
